(19) United States
(12) Patent Application Publication
(10) Pub. No.: US 2026/0296485 A1
(43) Pub. Date: Oct. 1, 2026

(54) Driver Assistance System and Driver Assistance Method for Automatically Driving a Vehicle

(71) Applicant: BAYERISCHE MOTOREN WERKE AKTIENGESELLSCHAFT, München (DE)

(72) Inventors: Jakob HUEMER, Muenchen (DE); Andreas SPAETH, Lindau (DE)

(21) Appl. No.: 19/477,157

(22) PCT Filed: May 16, 2024
(86) PCT No.: PCT/EP2024/063522

§ 371 Date: Oct. 21, 2025

(30) Foreign Application Priority Data
May 25, 2023 (DE) 10 2023 113 830.8

(51) Int. Cl. B60W 60/00; B60W 50/00; B60W 50/10; B60W 50/14

(52) U.S. Cl. CPC B60W 60/001; B60W 50/10; B60W 50/14; B60W 2050/0083; B60W 2050/146; B60W 2556/10

(57) ABSTRACT

A driver assistance system for automatically driving a vehicle, comprising a history module to store past driving routes of the vehicle; an analysis module to compare a current driving route with the past driving routes stored in the history module with respect to the current driving route frequency and/or type; and an assistance module for automatically driving the vehicle, said assistance module setting a function characteristic of the assistance module in order to automatically drive on the current driving route on the basis of the current driving route frequency and/or type.

### BACKGROUND AND SUMMARY

The present disclosure relates to a driver assistance system for automatically driving a vehicle, a vehicle having such a driver assistance system, a driver assistance method for automatically driving a vehicle, and a storage medium for carrying out the driver assistance method. The present disclosure relates in particular to a route-adaptive assistance form of a driver assistance function.

### PRIOR ART

Driver assistance systems for automatic driving are increasingly gaining importance. Automatic driving can take place with various degrees of automation. Exemplary degrees of automation are assisted, semiautomated, conditionally automated, highly automated, or fully automated driving. The above-mentioned five degrees of automation correspond to SAE levels 1 to 5 of the norm SAE J 3016 (SAE—Society of Automotive Engineering) according to the version of 30 Apr. 2021.

In fully automated driving (SAE level 5), all aspects of the dynamic driving task which are also managed by a human driver can be carried out by the system under any roadway and environmental condition.

In automatic driving, the longitudinal and/or lateral control of the vehicle takes place automatically. The driver assistance system thus takes over the vehicle control. For this purpose, the driver assistance system controls the drive, the transmission, the service brake, and the steering. Forms of the driver assistance, such as dynamic values of the longitudinal and/or lateral control, are defined here in the development phase and can be adapted by the final customer via profile setting (for example, via the setting of driving modes such as sport mode, comfort mode, and eco mode). However, such forms of the driver assistance can be unsuitable or perceived as unpleasant for some users and/or in specific situations, which can cause the user to deactivate the driver assistance. Deactivation of the driver assistance can have a negative effect on safety in road traffic, since the driver assistance often offers more safety in comparison to the manual driver.

### SUMMARY OF THE DISCLOSURE

It is an object of the present disclosure to specify a driver assistance system for automatically driving a vehicle, a vehicle having such a driver assistance system, a driver assistance method for automatically driving a vehicle, and a storage medium for carrying out the driver assistance method, which can maximize a usage duration of the driver assistance system and can therefore enhance safety in road traffic. In particular, it is an object of the present disclosure not to give a user a reason to deactivate the driver assistance system.

According to one independent aspect of the present disclosure, a driver assistance system for automatically driving a vehicle, in particular a motor vehicle, is specified. The driver assistance system comprises a history module which is configured to store or record preceding driving routes of the vehicle; an analysis module which is configured to compare a current driving route with the preceding driving routes stored in the history module with respect to a frequency and/or a type of the current driving route; and an assistance module for automatic driving which is configured to set a functional form of the assistance module for automatic driving on the current driving route based on the frequency and/or the type of the current driving route and optionally route conditions.

According to the disclosure, the current driving route is classified with respect to a type and/or frequency of this driving route using historic driving data. Based on this classification of the current driving route, the functional form of the assistance function is adapted. For example, a high level of driving dynamics can be permitted for frequently driven driving routes which are therefore known to the driver. For new driving routes which are therefore unknown to the driver, a low level of driving dynamics can be permitted. In this way, an overload of the driver on unknown roads due to a perceived excessively high level of driving dynamics can be avoided, so that the driver does not switch off the assistance function due to his discomfort. In other words, no reason for a deactivation of the driver assistance system is given to the driver due to the adaptation of the functional form to the type and/or frequency of the driving route. As a result, a usage duration of the driver assistance system can be maximized and therefore safety in road traffic can be enhanced.

The history module and/or the analysis module and/or the assistance module can be implemented in a common software and/or hardware module. Alternatively thereto, the history module and/or the analysis module and/or the assistance module can each be implemented in separate software and/or hardware modules.

The functional form of the assistance module for automatic driving preferably relates to a level of dynamics of a longitudinal and/or lateral control of the vehicle. The dynamics can relate to or be, for example, a vehicle speed and/or a steering behavior. For example, a higher level of dynamics can comprise a higher vehicle speed, for example in curves, and a lower level of dynamics can comprise a lower vehicle speed, for example in curves. Similarly, a higher level of dynamics can comprise faster and/or larger steering movements, and a lower level of dynamics can comprise slower and/or smaller steering movements. In other words, a low level of dynamics can correspond to a conservative or moderate driving style, and a high level of dynamics can correspond to a sporty or agile driving style.

Additionally or alternatively, the functional form of the assistance model for automatic driving relates to activating and/or deactivating automatic driving, in particular a time for activating and/or deactivating automatic driving. For example, on unknown driving routes, earlier deactivation of the automatic driving mode, and transfer of the vehicle control to the driver can take place than on known routes. In other words, deactivation criteria can engage earlier if the current driving route is an unknown driving route. In this way, it is possible to transfer the vehicle control to the driver early, due to which unpleasant situations during automatic driving on unknown driving routes can be avoided for the driver.

Additionally or alternatively, the functional form of the assistance module for automatic driving relates to at least one application parameter for automatic driving. The application parameters determine the vehicle behavior of the vehicle and can be adapted according to the classification of the current driving route.

Additionally or alternatively, the functional form of the assistance module for automatic driving relates to an information output with respect to automatic driving by at least one display device. This can be, for example, information on speed limits, right-of-way regulations of intersection situations, upcoming speed bumps, or tight curves. For example, an amount and/or type of the output information can be set based on the frequency and/or type of the current driving route. For example, a smaller scope of information can be output in the case of known driving routes than in the case of unknown driving routes.

The at least one output device can comprise at least one display device and/or at least one loudspeaker. The at least one display device can comprise a display, in particular an LCD display, a plasma display, or an OLED display. Additionally or alternatively, the at least one display device can comprise a projection device configured to show information directly in the field of view of the driver, in particular project it on a windshield. In some embodiments, the at least one display device can be a central information output device of an infotainment system, such as a head unit or a pillar-to-pillar display. The at least one output device is preferably permanently installed in the vehicle.

The analysis module is preferably configured to determine the frequency and/or type of the current driving route based on a driving destination and/or a duration and/or a time of day (e.g., morning, midday, afternoon, evening, and night), and/or a day (e.g., weekday, weekend, and holiday). The functional form of the assistance module for automatic driving can then be adapted based thereon.

In some embodiments, the analysis module can determine whether the current driving route is a repeating driving route or a first-time driving route and can moreover determine a type of the driving route. Based on the driving destination and/or the duration and/or the time of day and/or the day, for example, it can be determined whether the current driving route is a known driving route to work, a known driving route to a school, a known drive to a supermarket, etc. or whether the current driving route is an unknown driving route to a vacation destination or an excursion destination. The functional form of the assistance module for automatic driving can then be adapted based thereon.

The analysis module is preferably configured to determine a familiarity measure of the current driving route for a driver of the vehicle based on the frequency and/or type of the current driving route, wherein the assistance module is configured to set the functional form of the assistance module based on the familiarity measure of the current driving route. The familiarity measure can be defined suitably depending on the frequency and/or type of the driving route, such as “high familiarity” (for example, drives to work and/or home), “moderate familiarity” (for example, in the case of drives to a rarely visited physician), and “unknown” (for example, in the case of a drive to a new vacation destination or new excursion destination).

The history module is preferably assigned to driver profiles stored in the vehicle. The user profiles are recognized and selected, for example, via the vehicle key used or selected via an application of the driver profile in the vehicle. The familiarity measure of the current driving route can be determined specifically by driver by the assignment of a driver profile in the history module, even if the vehicle is used alternately by multiple people.

In some embodiments, the assistance module can be configured to set a higher level of dynamics of the longitudinal and/or lateral control of the vehicle for a higher familiarity measure of the current driving route than for a lower familiarity measure of the current driving route. For example, a higher level of dynamics can comprise a higher vehicle speed, therefore higher accelerations and/or decelerations, for example in curves, and a lower level of dynamics can comprise a lower vehicle speed, therefore lower accelerations and/or decelerations, for example in curves. Similarly, a higher level of dynamics can comprise faster steering movements, and a lower level of dynamics can comprise slower steering movements. In other words, a low level of dynamics can correspond to a conservative or moderate driving style, and a high level of dynamics can correspond to a sporty or agile driving style. In this way, it is possible to avoid unpleasant situations for the driver during automatic driving on unknown driving routes.

The analysis module is preferably configured to determine a driver intention for the drive along the current driving route based on the frequency and/or type of the current driving route, wherein the assistance module is configured to set the functional form of the assistance module for automatic driving on the current driving route based on the driver intention.

In some embodiments, the driver intention can relate to a time (for example, an urgency) and/or the surroundings of the current driving route (for example, scenery). For example, the driver can be in a hurry on frequently traveled driving routes, such as to work or home, so that rapid driving is desired on the part of the driver. In this case, a sporty or agile driving style can be selected. In a further example, the driver may not be in a hurry on driving routes which are traveled rarely or not at all, such as to a vacation destination or excursion destination, so that unhurried driving is desired on the part of the driver, for example to be able to observe the scenery outside the vehicle. In this case, a moderate or conservative driving style can be selected.

The assistance module is preferably configured to furthermore set the functional form of the assistance module based on at least one situational route condition. The at least one situational route condition can relate to or be, for example, a drive in an urban area and/or a drive in an interurban area. For example, a moderate or conservative functional form can be set in an urban area so that the driver is not unsettled due to an excessively high level of dynamics in the urban environment having complex route courses, intersection situations, and/or a high number of further road users. Similarly, in the interurban area having few other road users, a sporty functional form can be set since the driver is not unsettled in spite of the high level of dynamics. As a further example of situational route conditions, local weather conditions (e.g., precipitation, fog, slippery roads) can be taken into consideration in the assistance module and the functional form can be adapted accordingly.

According to a further independent aspect of the present disclosure, a vehicle, in particular a motor vehicle, is specified. The vehicle comprises the driver assistance system for automatic driving according to the embodiments of the present disclosure.

The term vehicle comprises passenger vehicles, trucks, buses, caravans, motorcycles, etc. which are used to convey people, goods, etc. In particular, the term comprises motor vehicles for conveying people.

The term “automatic driving” is understood in the context of the document as driving using automatic longitudinal and/or lateral control. Automatic driving can involve, for example, driving for a longer time on the freeway or in the city. The term “automatic driving” comprises automatic driving with an arbitrary degree of automation. Exemplary degrees of automation are assisted, semiautomated, conditionally automated, highly automated, and fully automated driving (with increasing degree of automation in each case). The above-mentioned five degrees of automation correspond to SAE levels 1 to 5 of the norm SAE J 3016 (SAE—Society of Automotive Engineering) according to the version of 30 Apr. 2021.

In assisted driving (SAE level 1) the system carries out the longitudinal or lateral control in specific driving situations. In semiautomated driving (SAE level 2) the system takes over the longitudinal and lateral control in specific driving situations, wherein the driver has to continuously monitor the system as in assisted driving. In conditionally automated driving (SAE level 3) the system takes over the longitudinal and lateral control in specific driving situations without the driver having to continuously monitor the system; however, the driver has to be capable within a specific time of taking over the vehicle control upon request by the system. In highly automated driving (SAE level 4) the system takes over the vehicle control in specific driving situations, even if the driver does not react to a request to intervene, so that the driver is dispensed with as a fallback level. In fully automated driving (SAE level 5), all aspects of the dynamic driving task which are also managed by a human driver can be carried out by the system under any roadway and environmental condition.

In addition, the term “at least semiautomated driving or maneuvering” is also understood in the context of the document as semiautomated, conditionally automated, highly automated, or fully automated driving. In other words, a degree of automation from SAE level 2 inclusive is thus understood under the term “at least semiautomated driving”.

The driver assistance system is preferably configured for an adaptive cruise control (ACC). Adaptive cruise control is a cruise control system which takes into consideration the distance to a preceding vehicle as an additional feedback and control variable in the control. In adaptive cruise control, the position and the speed of the preceding vehicle are ascertained using a sensor and the speed and the distance are adaptively controlled using motor and brake intervention. Moreover, the driver assistance system is preferably configured for lateral control of the vehicle (lane and steering assist, LSA).

According to a further independent aspect of the present disclosure, a driver assistance method for automatically driving a vehicle, in particular a motor vehicle, is specified. The driver assistance method comprises storing, in a history module, preceding driving routes of the vehicle; comparing a current driving route with the preceding driving routes stored in the history module with respect to a frequency and/or a type of the current driving route; and setting a functional form of an assistance module for automatically driving on the current driving route based on the frequency and/or type of the current driving route.

The driver assistance method for automatically driving a vehicle can implement the aspects of the driver assistance system for automatically driving a vehicle which are described in this document.

According to a further independent aspect of the present disclosure, a software (SW) program is specified. The SW program can be configured to be executed on one or more processors and to thus carry out the driver assistance method for automatically driving a vehicle which is described in this document.

According to a further independent aspect of the present disclosure, a storage medium is specified. The storage medium can comprise an SW program, which is configured to be executed on one or more processors, and to thus carry out the driver assistance method for automatically driving a vehicle which is described in this document.

According to a further independent aspect of the present disclosure, software having program code is specified. The software is configured to carry out the driver assistance method for automatically driving a vehicle when the software runs on one or more software-controlled devices.

According to a further independent aspect of the present disclosure, a driver assistance system for automatically driving a vehicle is specified. The driver assistance system comprises one or more processors; and at least one memory, which is connected to the one or more processors and contains instructions which can be executed by the one or more processors in order to carry out the driver assistance method for automatically driving a vehicle which is described in this document.

A processor or a processor module is a programmable computing mechanism, thus a machine or an electronic circuit, which controls other elements according to transferred commands and advances an algorithm (process) in this case.

### BRIEF DESCRIPTION OF THE DRAWINGS

FIG. 1 schematically shows a vehicle having a driver assistance system for automatic driving according to embodiments of the present disclosure;

FIG. 2 schematically shows a driver assistance system for automatic driving according to embodiments of the present disclosure; and,

FIG. 3 shows a flow chart of a driver assistance method according to embodiments of the present disclosure.

### DETAILED DESCRIPTION OF THE DRAWINGS

Identical reference signs are used hereinafter, if not noted otherwise, for identical and identically-acting elements.

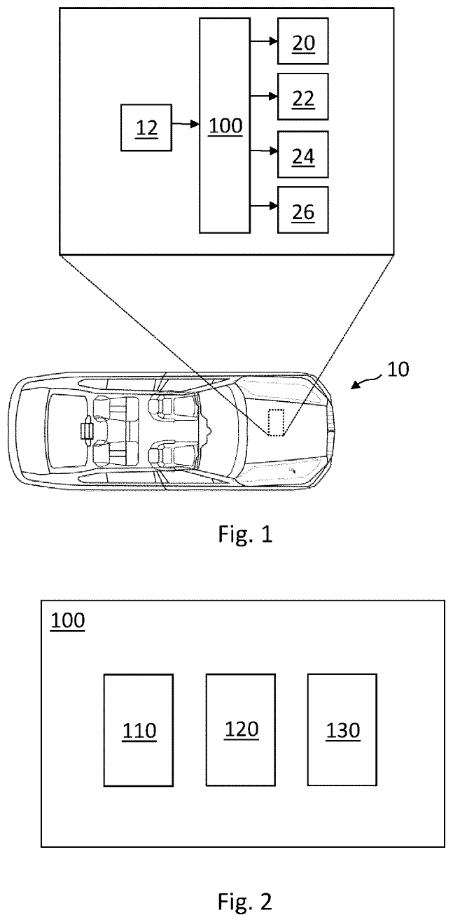

FIG. 1 schematically shows a vehicle 10 having a driver assistance system 100 for automatic driving according to embodiments of the present disclosure.

In automatic driving, the longitudinal and/or lateral control of the vehicle 10 takes place automatically. The driver assistance system 100 thus takes over the vehicle control. For this purpose, the driver assistance system 100 controls the drive 20, the transmission 22, the (for example, hydraulic) service brake 24, and the steering 26 via intermediate units (not shown).

Surroundings information of a surroundings sensor system which observes the vehicle surroundings is accepted by the driver assistance system 100 for planning and carrying out the automatic driving. In particular, the vehicle can comprise at least one surroundings sensor 12, which is configured to record surroundings data that specify the vehicle surroundings. The at least one surroundings sensor 12 can comprise, for example, one or more lidar systems, one or more radar systems, one or more ultrasonic sensors, and/or one or more cameras.

According to the disclosure, the current driving route is classified with respect to a type and/or frequency of this driving route using historic driving data. The functional form of the driver assistance system 100 is adapted based on this classification of the current driving route.

For example, a user picks up a new vehicle having an adaptive cruise control (ACC) at the seller and now wishes to test the adaptive cruise control on the return drive home. The route home is unknown to the user and therefore he has to direct a large part of his attention to the route management. The adaptive cruise control would, with predetermined high level of dynamics, accelerate strongly on the unknown route, which could frighten the user and result in a deactivation of the adaptive cruise control. According to the disclosure, however, the adaptive cruise control adapts itself to the unknown route and limits the level of dynamics to lower values. A positive experience with the adaptive cruise control is therefore enabled for the user already upon first contact, which has the result that the user also continues to use the function and does not deactivate it.

FIG. 2 schematically shows a driver assistance system 100 for automatic driving according to embodiments of the present disclosure.

The driver assistance system 100 comprises a history module 110, which is configured to store preceding driving routes of the vehicle 10; an analysis module 120 which is configured to compare a current driving route with the preceding driving routes stored in the history module 110 with respect to a frequency and/or a type of the current driving route; and an assistance module 130 for automatic driving, wherein the assistance module 130 is configured to set a functional form of the assistance module 130 for automatic driving on the current driving route based on the frequency and/or type of the current driving route.

For example, directly after a purchase of the vehicle 10, a new driver profile can be created, wherein initially standard parameters are set for the driver assistance systems, such as a configuration of an activation/deactivation of the driver assistance systems, a specification of application parameters, dynamics values, etc. In the further use of the driver assistance systems, the functional forms of the driver assistance systems can be adapted in accordance with the planned driving routes. For this purpose, the type and/or frequency of the respective driving route are taken into consideration (for example, daily way to work, weekend excursion, longer journey, etc.), and optionally situational route conditions of the driving route.

For the classification of the type and/or frequency of the driving route(s), navigation routes and/or route courses from a localization can be evaluated and classified. The respective driving routes can also be assessed here with respect to a duration and/or a distance and/or a time of day and/or a day of the week. The classifications ascertained in this case can be assigned to a driver profile. Depending on the classification of the current driving route, the assistance function can be adapted to the respective assessment of the preceding driving route upon renewed use.

In a first example, a frequency with which the current driving route is traveled by the driver can be determined. Moreover, a measure can be determined for whether the driver knows the driving route sufficiently. If this is the case, a more dynamic form of the assistance function can be set, such as a higher speed level, higher acceleration values, a smaller scope of information in a user interface, etc.

In a second example, the current driving route can be classified as a daily repeating driving route, for example to work or home, for example with the goal of the fastest possible accomplishment of the driving route. A more dynamic form of the assistance function can also be set here.

In a third example, the current driving route can be classified as a rare weekend excursion or longer journey on unknown route areas. If this is the case, a conservative form of the assistance function can be set, such as a lower speed level, lower acceleration values, a larger scope of information in a user interface, more extensive warnings, etc.

In addition to the classification of an overall driving route from the comparison of the planned driving route with the preceding journeys, situational route conditions can also be taken into consideration. For example, in a recognized urban space (for example, by means of map data and/or a surroundings sensor system), a conservative form of the assistance function can be set. In a further example, a more dynamic form of the assistance function can be set at night on a freeway without further road users.

It is therefore ensured that the driver is not overloaded on unknown driving routes and/or in the case of complex route conditions by a driver assistance system which is still unknown to him and/or acts excessively dynamically.

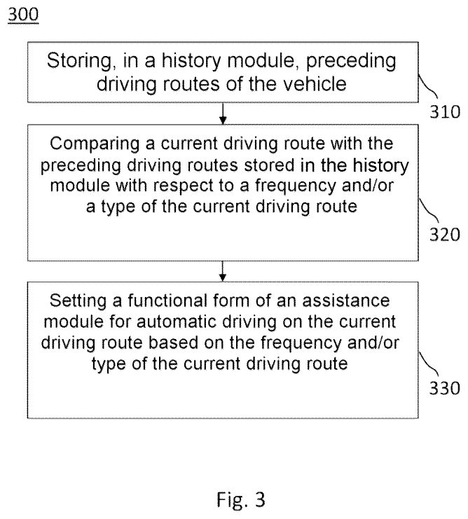

FIG. 3 schematically shows a flow chart of a driver assistance method 300 for automatically driving a vehicle according to embodiments of the present disclosure. The driver assistance method 300 can be implemented by corresponding software, which is executable by one or more processors (such as a CPU).

The driver assistance method 300 comprises, in block 310, storing, in a history module, preceding driving routes of the vehicle; in block 320, comparing a current driving route with the preceding driving routes stored in the history module with respect to a frequency and/or a type of the current driving route; and in block 330, setting a functional form of an assistance module for the automatic driving on the current driving route based on the frequency and/or type of the current driving route.

According to the disclosure, the current driving route is classified with respect to a type and/or frequency of this driving route using historic driving data. Based on this classification of the current driving route, the functional form of the assistance function is adapted. For example, a high level of driving dynamics can be permitted for frequently driven driving routes which are therefore known to the driver. For new driving routes which are therefore unknown to the driver, a low level of driving dynamics can be permitted. In this way, an overload of the driver on unknown routes due to a perceived excessively high level of driving dynamics can be avoided, so that the driver does not switch off the assistance function due to his discomfort. In other words, no reason for a deactivation of the driver assistance system is given to the driver due to the adaptation of the functional form to the type and/or frequency of the driving route. As a result, a usage duration of the driver assistance system can be maximized and therefore safety in road traffic can be enhanced.

Although the disclosure was illustrated and explained in more detail by preferred exemplary embodiments, the disclosure is not thus restricted by the disclosed examples and other variations can be derived therefrom by a person skilled in the art without departing from the scope of protection of the disclosure. It is therefore clear that a variety of possible variations exist. It is likewise clear that embodiments mentioned as examples actually only represent examples, which are not to be interpreted in any way as a limitation, for example, of the scope of protection, the possible applications, or the configuration of the disclosure. Rather, the preceding description and the description of the figures make a person skilled in the art capable of specifically implementing the exemplary embodiments, wherein a person skilled in the art who is aware of the disclosed concept of the disclosure can perform manifold modifications, for example, with respect to the function or the arrangement of individual elements mentioned in an exemplary embodiment without departing from the scope of protection defined by the claims and their legal equivalents, such as more extensive explanations in the description.

1-10. (canceled)

11. A driver assistance system for automatically driving a vehicle, comprising:
a history module configured to store preceding driving routes of the vehicle;
an analysis module configured to compare a current driving route with the preceding driving routes stored in the history module with respect to a frequency and/or a type of the current driving route; and
an assistance module for automatic driving configured to set a functional form of the assistance module for automatic driving on the current driving route based on the frequency and/or type of the current driving route.

12. The driver assistance system according to claim 11, wherein the functional form of the assistance module for automatic driving relates to at least one of the following aspects:
a level of dynamics of a longitudinal and/or lateral control of the vehicle; and/or
activating and/or deactivating the automatic driving; and/or
at least one application parameter for automatic driving; and/or
an information output by at least one display device.

13. The driver assistance system according to claim 11, wherein the analysis module is configured to determine the frequency and/or type of the current driving route based on a driving destination and/or a duration and/or a time of day and/or a day.

14. The driver assistance system according to claim 11, wherein the analysis module is configured to determine a familiarity measure of the current driving route for a driver of the vehicle based on the frequency and/or type of the current driving route, and wherein the assistance module is configured to set the functional form of the assistance module based on the familiarity measure of the current driving route.

15. The driver assistance system according to claim 14, wherein the assistance module is configured to set a higher level of dynamics of the longitudinal and/or lateral control of the vehicle for a higher familiarity measure of the current driving route than for a lower familiarity measure of the current driving route.

16. The driver assistance system according to claim 11, wherein the analysis module is configured to determine a driver intention for the drive along the driving route based on the frequency and/or type of the current driving route, and wherein the assistance module is configured to set the functional form of the assistance module for automatic driving on the current driving route based on the driver intention, in particular wherein the driver intention relates to a time and/or the surroundings of the current driving route.

17. The driver assistance system according to claim 11, wherein the assistance module is configured to furthermore set the functional form of the assistance module based on at least one situational route condition, wherein the at least one situational route condition relates to a drive in an urban area and/or a drive in an interurban area.

18. A vehicle comprising the driver assistance system according to claim 11.

19. A driver assistance method for automatically driving a vehicle, comprising:
storing, in a history module, preceding driving routes of the vehicle;
comparing a current driving route with the preceding driving routes stored in the history module with respect to a frequency and/or a type of the current driving route; and
setting a functional form of an assistance module for automatic driving on the current driving route based on the frequency and/or type of the current driving route.

20. A storage medium, comprising a software program which is configured to be executed on one or more processors and to carry out the driver assistance method according to claim 19.
